(19) United States
(12) Patent Application Publication
(10) Pub. No.: US 2008/0140895 A1
(43) Pub. Date: Jun. 12, 2008

(54) Systems and Arrangements for Interrupt Management in a Processing Environment

(75) Inventors: Marcus A. Baker, Apex, NC (US); Cody I. Gillians, Raleigh, NC (US); Mauricio Gonzalez, Cary, NC (US); Randolph S. Kolvick, Durham, NC (US)

Correspondence Address: IBM COPORATION (RTP);C/O SCHUBERT OSTERRIEDER & NICKELSON PLLC, 6013 CANNON MOUNTAIN DRIVE, S14, AUSTIN, TX, 78749, US

(73) Assignee: INTERNATIONAL BUSINESS MACHINES CORPORATION, Armonk, NY (US)

(21) Appl. No.: 11/608,817

(22) Filed: Dec. 9, 2006

(51) Int. Cl. G06F 13/24

(52) U.S. Cl. 710/262

(57) ABSTRACT

Methods and arrangements for managing interrupts in a processing system are disclosed. The method can determine an indication of an interrupt request from a peripheral entity, identify the peripheral entity associated with the indication, count occurrences of the indications; and flag the peripheral entity in response to the counted occurrences. When the counted occurrences reach a predetermined number in the predetermined time interval, interrupts from the peripheral entity can be ignored or the entity can be identified as having possible operational problems.

### FIELD OF INVENTION

The present disclosure is in the field of processors and particularly to detection and management of interrupts in a processing environment.

### BACKGROUND

Most modern computer systems include some form of a processor and smaller computer systems typically utilize a processor commonly referred to as a micro-processor. In operation, a processor will typically retrieve instructions from memory and execute the instructions thereby processing data. While processing data, devices such as disk drives, printers, scanners etc. can send interrupts to the processor, where in response to the interrupt the processor will put the current process on hold and perform the process requested by the interrupt. In addition internal peripherals or system management interrupts may request assistance from the processor, or in other words, interrupt the processor via an interrupt request.

While the processor performs tasks such as refreshing a display, displaying the time etc, and a device or port in the system needs attention, an interrupt request can be received by the processor and the processor can transmit or provide indications of its processing status. For example the processor can indicate that it has reacted to an interrupt request or it has completed the processing of an interrupt request. The interrupt request can be received over dedicates pins or conductors on a processor integrated circuit or the interrupt request can be received over a data bus possibly as a 64 bit message or “quad word.” Such communication is commonly referred to as an Interrupt Request (IRQ) and an interrupt request acceptance (IRA). Generally, once the processor receives an IRQ, it can finish its current instruction, places the data and instructions under current execution in storage or “on a stack”, and then can execute the appropriate Interrupt Service Routine (ISR) which can provide an appropriate status communication to other devices in the system. Once the ISR has finished administrating the interrupt, the processor can retrieve the previously stored data and instructions from the stack and continue to execute instructions where it left off. Systems that utilize interrupts are more efficient than “polling systems because a processor doesn't have to waste time, continually looking to see if each port or device is in need of service/attention, but rather the device will interrupt the processor when it needs attention.

As stated above, typically, the processor responds to an interrupt request by halting execution of the next instruction and servicing the device or entity that has requested an interrupt. Upon completion of the interrupt service routine, the processor can resume normal program flow. At any given time there may be several interrupt sources that require servicing including hardware entities and software entities. For example, internal to the processor a completion of an A/D conversion process (an internal software entity) may temporarily require the processors resources or a timer overflow might occur temporarily require the processors resources. Also processors can have pins, ports or inputs to receive external interrupt signals. Thus, a signal on an external interrupt pin can also request and cause an interrupt. Naturally, some sources or interrupts can have higher priority than others. Hence, for efficient system operation, interrupts should be managed according to a technologically advanced or sophisticated protocol.

Some computer systems have interrupt subsystem that are responsible for prioritizing interrupts and are responsible to ensure that interrupts with a higher priority are serviced before interrupts of a lower priority. Another interrupt component, an interrupt control unit (ICU) can assist in loading interrupt software into the processor in response to an interrupt request. Such interrupt software can instruct the processor to store its current instructions and data, and load instructions according to a specific interrupt process. Such an interruption and such continuous interruptions can make a processing system inefficient because the processor must perform “housekeeping” or tracking functions and load and unload functions every time it is interrupted and every time it recovers from the interrupt.

When a device such as a printer or a network controller is malfunctioning and continually or even sporadically sending interrupts to a processor, this can significantly degrade system performance, particularly when processing of such interrupts does not accomplish a useful goal or complete a task. Often, when a peripheral entity is malfunctioning, processing these interrupts may keep the entity in an endless processing loop where resources are tied up but no finality to a process can be achieved. For example, a printer may have a processor that is locked up continually processing in an endless loop where the printer continually sends an interrupt to the main processor, receives the results from the interrupt and milliseconds later sends a similar interrupt to processor. When this occurs, the main processor may spend the majority of its time entering and exiting an interrupt mode and not be able to complete main processing tasks.

As can be appreciated, continually addressing inconsequential interrupts creates significant inefficiencies in a computer system and a computer system may become non-responsive to user input or very slow to respond to user commands. This situation is generally unacceptable and market pressure forces computer manufacturers to create products that have minimal failures. Some newer computer systems implement a service processor that runs concurrently with the main processor and performs as a “watchdog” to avoid such lock up conditions. A service processor can be a separate microprocessor subsystem that provides surveillance of system operation and reboots devices or repairs operational problems, logs the problems and provides “de-bugging” tools for a user.

The service processor can be automatically enabled to check for “heartbeats” from the main or core processor, where a heartbeat detector can look for toggling signals at various locations in a circuit and assume that the circuit is operating appropriately when such toggling is detected. The heartbeat detector can be a software mechanism where a background task sends a message to a service processor possibly every thirty seconds. Id the processor does not respond within say sixty seconds of the request transmission the heartbeat monitor assumes that the processor or the computer has locked -up and is malfunctioning. If a heartbeat is not detected within a specified time period, the service processor may record such phenomena and report it to a user or an administrator. Such service processors are particularly useful in high reliability/high availability systems, including servers and other telecommunication systems. However even state of the art service processors do not manage interrupts for a processor.

### SUMMARY OF THE INVENTION

The problems identified above are in large part addressed by the apparatuses systems, methods, and arrangements disclosed herein to detect interrupts that result from a malfunctioning entity within a computing or processing system. In one embodiment, a method for detecting and managing inconsequential interrupt requests is disclosed. The method can determine an indication of an interrupt request, identify a peripheral entity associated with the indication, count occurrences of the indications; and flag the peripheral entity in response to the occurrence of a predetermined/abnormally high number of interrupt request occurrences.

The counting can be done during a predetermined time interval such that a frequency or interrupt requests per unit of time can be acquired. If the count is greater than a predetermined level in the predetermined time interval, then interrupts from the entity can be ignored, lowered in priority, the entity can be identified as having possible operational problems and can be reset or powered down and an error message can be generated and sent. Thus, the entity can be deactivated or ignored in response to a predetermined number of interrupt request occurrences in the predetermined time interval.

In one embodiment, the entity can be assigned an identifier by the interrupt management system if no system wide identifiers are currently assigned. The assigned identifiers can be stored in a register with an occurrence count and when the occurrence count reaches a predetermined level, the identifier and entity can be flagged as a suspect entity that is adversely effecting system performance. Thus, an interrupt request count can be incremented in response to individual detections of interrupt requests.

In another embodiment, an interrupt processing system is disclosed. The system can include a processor, an interrupt management module coupled to the processor to determine indications of an interrupt request directed to the processor, where the indications can have an identifier relating the interrupt request to a peripheral entity. The system can further include a counter to count the occurrences of the interrupt requests during a predetermined time interval and a periphery entity malfunction log module to store the identifier responsive to the count of occurrences during the predetermined time interval. Individual entities can receive individual treatment or their interrupt requests based on the number of interrupt requests they make and based on user configurable treatments such that some entitles will never be ignored while other will be ignored after creating very few interrupts.

The system can also include a timer to determine the predetermined time interval, a service processor to query the periphery entity flagged by malfunction log and to determine if the interrupts from the periphery entity should executed. The system can also include a peripheral transaction server to process the interrupts and an interrupt service routine module to provide executable code to the processor such that the processor can execute the interrupt.

In another embodiment, a computer program product is disclosed. The computer program product can include a computer useable medium having a computer readable program, wherein the computer readable program when executed on a computer can causes the computer to determine an indication of an interrupt request, identify a peripheral entity associated with the indication, count occurrences of the indications and flag the peripheral entity in response to the counted occurrences. The program product can further include computer readable program when executed on a computer that causes the computer to set a predetermined time interval for monitoring interrupt requests. Additionally, the product when executed can cause the computer to ignore the peripheral entity in response to a predetermined number of interrupt occurrences in the predetermined time interval. The entity can also be deactivated in response to a predetermined number of occurrences in the predetermined time interval.

### BRIEF DESCRIPTION OF THE DRAWINGS

Aspects of the invention will become apparent upon reading the following detailed description and upon reference to the accompanying drawings in which, like references may indicate similar elements:

FIG. 1 depicts a block diagram of a computer system with an interrupt management system;

FIG. 2 illustrates a more detailed block diagram of an interrupt management system; and

FIG. 3 depicts a flow chart showing interrupt management methods.

### DETAILED DESCRIPTION OF EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. The descriptions below are designed to make such embodiments obvious to a person of ordinary skill in the art.

While specific embodiments will be described below with reference to particular configurations of hardware and/or software, those of skill in the art will realize that embodiments of the present invention may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

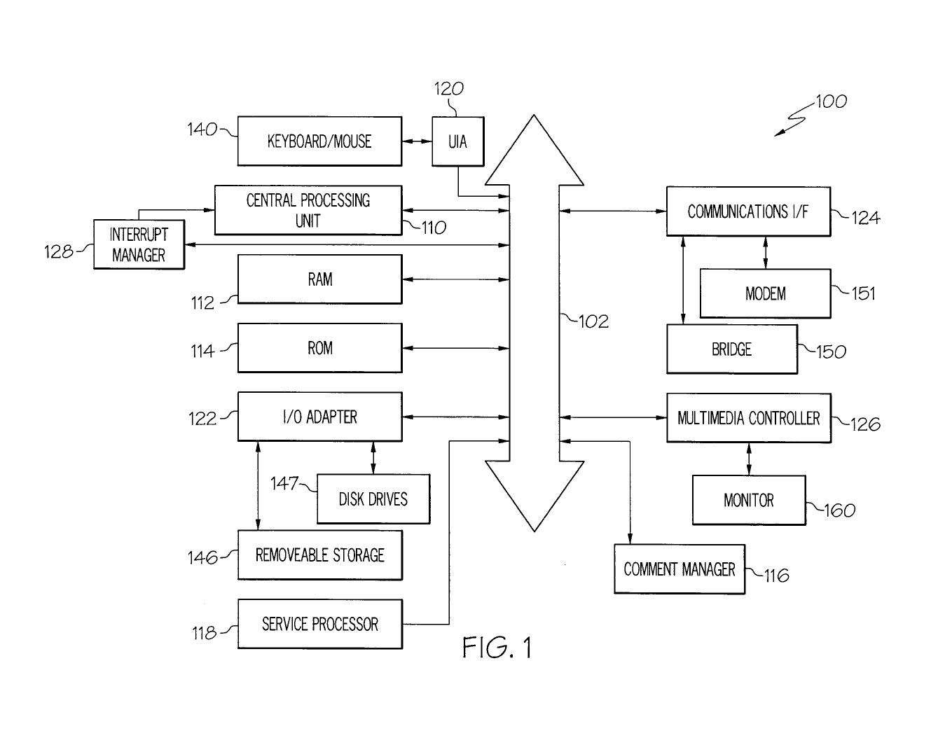

Turning now to the drawings, FIG. 1 illustrates, in a block diagram format, a processing device such as a personal computer system 100. The disclosed system 100 can monitor interrupts sent to the central processing unit (CPU) 110 and based on interrupt requests of the CPU 110 or interrupt request activity, identify peripheral entities that may be malfunctioning.

A peripheral entity suspected of malfunctioning can be identified based on frequent interrupt requests from the peripheral entity or some other abnormality related to interrupt requests from the peripheral entity. A peripheral entity can be a piece of hardware that resides external to the CPU 110 or a peripheral entity can be a software routine or executable code within the CPU 110 or other module that can generate an interrupt request. Likewise an interrupt can be a “hot” interrupt request. The hot interrupt request can be a system management based interrupt or a device interrupt. Thus, a peripheral entity (an “entity”) can be understood broadly as any executable code or hardware that can generate an interrupt request for a core processor such as CPU 110.

When it is detected that an entity is sending a high number of interrupt requests either directly or indirectly to the CPU 110 the disclosed system 100 or another system such as a failure monitor and analysis system can conduct a more in-depth investigation into the state of the entity sending the high number of interrupts. In one embodiment the entity sending the high number of interrupts can be flagged or tagged as a malfunctioning candidate and placed in a log such that multiple subsystems can have access to such information.

For example, the candidate can be monitored and interrogated to see if it is operating properly. If it is not operating properly the device can be flagged and possibly deactivated. In another embodiment the interrupt requests received from a suspect device can be ignored by the system 100. Generally, the computing system 100 is one of many types of systems that can implement the interrupt management system and arrangements disclosed herein.

The interrupt management arrangements disclosed herein can operate concurrently with the execution of computer code. Such computer code can include operating system code and specific code designed for specific applications. Thus, the system 100 can execute an entire suite of software that runs on an operating system, and the system 100 can perform a multitude of processing tasks in accordance with the loaded software application(s). Although a basic personal computer platform will be described herein, workstations or mainframes, servers and other configurations, operating systems or computing environments would not part from the scope of the disclosure.

The computer system 100 is illustrated to include a central processing unit 110, which may be a conventional proprietary data processor, and memory, including random access memory 112 and read only memory 114. The system 100 can further include an interrupt manager 128, an input output (I/O) adapter 122, a user interface adapter (UIA) 120, a communications interface adapter 124, a service processor 118 and a multimedia controller 126.

The I/O adapter 122 can be connected to, and control, disk drives 147, printer 145, removable storage devices 146, as well as other standard and proprietary I/O devices. Also, the UIA 120 can be considered to be a specialized I/O adapter. As illustrated the UIA 120 can be connected to a mouse and a keyboard 140. In addition, the UIA 120 may be connected to other devices capable of providing various types of user control, such as touch screen devices (not shown).

The communications interface adapter (I/F) 124 can be connected to a bridge 150 to bridge with a local or a wide area network, and a modem 151. By connecting the system bus 102 to various communication devices, external access to information can be obtained. For example the service processor 118 may be a part of a bigger monitoring system. Further, maintenance and monitoring systems such as those found in high reliability, high availability clustered systems (illustrated by service processor 118) can be connected to system bus 102. Such monitoring/reporting reliability systems can communicate with, exchange data with and utilize data from the interrupt manager 128.

The multimedia controller 126 will generally include a video graphics controller capable of displaying images upon the monitor 160, as well as providing audio to external components (not illustrated). Generally, the interrupt management methods described herein can be executed by the interrupt manager 128 which can monitor activities related to or that provide indications of interrupt activities or interrupt signals or request can be communicate to the CPU 110.

Some interrupt requests can be communicated over the system bus 102, while others can be a single conductor or hardwired. In other embodiments the interrupt manager 128 can be internal to the CPU 110 and can monitor interrupts coming from peripheral entities such as processing logic or combinational logic within the CPU 110. Generally, the interrupt manager 128 could be integrated on the same integrated circuit with the CPU 110 and/or implemented as a separate module as part of a system monitor or computer maintenance management system. Thus, in one embodiment interrupt manager 128 can detect all interrupts processible by the CPU 110 regardless of origin.

The disclosed system 100 can execute an interrupt procedure utilizing a software service routine. By setting and/or clearing individual bits in special function registers in the interrupt manager 128, interrupts from specific entities can be enabled or disabled. The interrupt manager 128 can also prioritize the interrupts based on a hunch that some of the interrupt requests are coming from a malfunctioning entity. In one embodiment an interrupt service routine may be interrupted by another interrupt source, in which case, the completion of the current service routine will be preempted by the new interrupt's request to be serviced if the new interrupt has a higher priority than the interrupt that is currently being processed.

As stated above, the monitoring process for interrupts may monitor the system bus 102 for particular binary sequences (a multi-bit signal), it could monitor individual lines or conductors for specific logic values, or it could monitor interrupt related code or hardware for specific phenomena. Thus, a hard detection of a request to the CPU 110 is not a requirement for the interrupt manager 128 to store an indicator of an interrupt request as many other signals or signal transitions that can directly or indirectly indicate that a possible interrupt request has been made. Many things could be monitored to determine an indication that an interrupt will be, has been, or is being requested.

Interrupt management in accordance with the present disclosure can increase the efficiency of the central processing unit 110 and of an entire system generally, particularly when interrupt activity is caused by malfunctioning devices that repeatedly requests an interrupt. The interrupt manager 18 could also be part of a system wide fault-tolerant, reliability, availability, serviceability, survivability, or troubleshooting system that monitors multiple processors, servers, subsystems and/or computer systems. Thus, the actual connections and outputs of the interrupt manager 128 should not be utilized to limit the scope of the present disclosure.

In one embodiment, interrupt detection apparatuses, systems and methods can be implemented as a “housekeeping” feature focused on servicing a single CPU. Accordingly, the interrupt manager 128 can be a system or component designed so that, in the event that a component capable of generating interrupts fails and continually interrupts a processor, the interrupt manager can immediately implement a backup procedure such that no loss of service or major interruption in system operation occurs. The fault tolerant procedure can be implemented with software, or embedded in hardware, or provided by some combination thereof.

Generally, when an interrupt request is detected by the interrupt manager 128, the source of the interrupt request including some form of identifier of the peripheral entity making the interrupt request can be determined, created or utilized. When such an identifier is determined, it can be stored by the interrupt manager 128. The interrupt manager 128 can also store a count of the interrupt requests made by each peripheral entity. Thus, the system 100 can assign an interrupt request count to individual entity identifiers based on how many interrupt requests have been originated by activities of the entity.

In one embodiment, the identifier can be a bus address or a device address. Such a buss/device address identifier assignment can be stored in RAM 112 or ROM 114. Accordingly, interrupt manager 128 could access RAM 112 and ROM 114 to identify peripherals based on interrupts request communications that contain the specific buss/device addresses. Thus, every time an interrupt request having an associated identifier is transmitter over the system bus 102 the interrupt manager can store indicia of the request and an associated identifier to track the number of interrupts sent by peripheral entities connected to the CPU 110 or connected generally to the system 100. In accordance with the present disclosure, all of the abovementioned components can be interconnected with a system bus 102 such that the interrupt manager 128 can monitor the flow of requests from devices and/or peripheral entities to the CPU 110 over the bus.

In operation, the CPU 110 can accept and store an interrupt request and the interrupt manager 128 can identify the device/peripheral entity sending the interrupt even though the interrupt may have a different formats and be indirectly caused by activities of a specific entity. The number of times that a particular entity requests an interrupt in a given time period can be stored by the interrupt manager 128. When a device has a high interrupt request rate in a predetermined time period, then the entity can be flagged for further investigation regarding why the device is requesting the high number or a high frequency of interrupts.

An interrupt counter that counts a number or interrupts for each device for the given time threshold can be set such that if the interrupt frequency threshold is reached, the interrupt manager 128 can log such activity and provide data regarding such activity (potential errors, and reasons for slow processing times) to the service processor 118.

In addition, the interrupt manager 128 could access error logs in the service processor 118, and based on user configurable options the interrupt manage 128 could cause the CPU 110 to ignore interrupts based on operational data of the system. Such operations can increase system efficiency. The service processor 118 can be designed to report errors to a service focal point where data regarding failures, malfunctions and suspected operational deficiencies can be collaborated and analyzed by various hardware and software entities. Any of the devices or software applications that can connect with, communicate with, or can be coupled to the CPU 110 either directly, or indirectly and can exchange information with the CPU 110 are considered a peripheral entity herein.

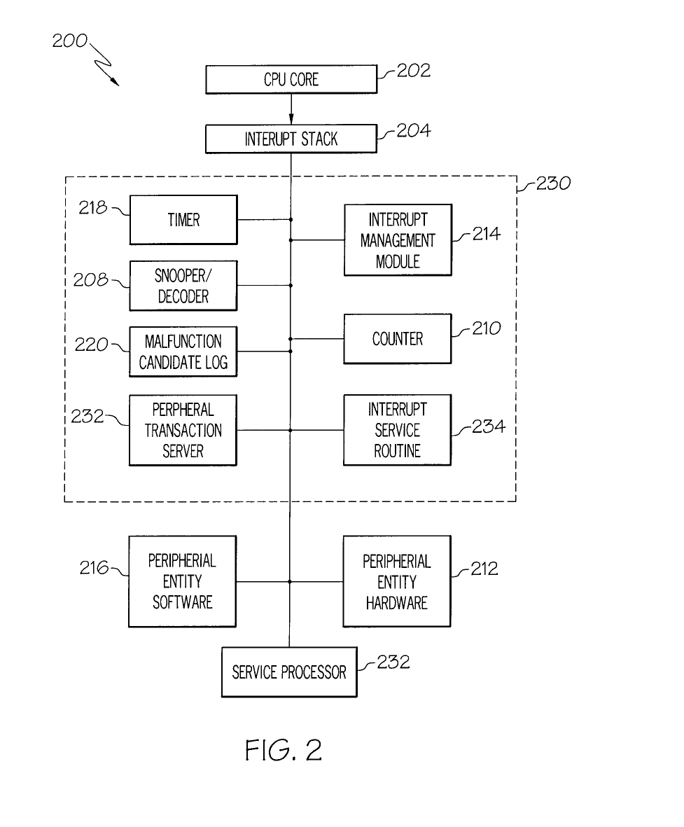

Referring to FIG. 2, a block diagram of an embodiment of a portion of a computer system 200 that includes interrupt management components in the dashed box 230 is depicted. The interrupt management components can function similar to, the interrupt manager 128 illustrated in FIG. 1. The interrupt management components can include timer 218, snooper 208, malfunction candidate log 214, peripheral transaction server 232, interrupt management module 214, counter 210, and interrupt service routine 234. In one embodiment, the interrupt management components can be implemented on the same integrated circuit with the CPU core 202.

The computer system 200 can include a processing unit such as CPU core 202, interrupt stack 204, external peripheral software entities 216 and peripheral hardware entities 212 and a service processor 232. Peripheral entities 216 and 212 could be devices or software that are operated/processed by some form of controller. Such entities (216 and 212) could be a smaller processor operating on software instructions or could simply be combinational logic. The CPU core 202 can read and execute a suite of software tools commonly bundled to form, at least part of an operating system. The CPU core 202 can also process specialized software applications that can run under the control of the operating system.

In operation, when the CPU core 202 is processing data and a peripheral entity such as 216 and 212 requests that the CPU core 202 be interrupted, the interrupt manager 214 can log the interrupt request and, the CPU core 202 can look to the malfunction candidate log 220 to see if the interrupt should be processed or ignored based on historical interrupt data. In one embodiment, the interrupt management module 214 can time stamp each interrupt occurrence, link the interrupt request to an entity and store such data, then determine if the entity or the interrupt management module is being invoked too frequently.

If the periphery entity that has made the request has not made frequent requests and has not been identified as a malfunctioning entity then the CPU core 202 can proceed to process the interrupt request. If the entity requesting the interrupt has been identified in the malfunction candidate log 220 as a malfunctioning component then the interrupt can be ignored by the CPU core 202.

The interrupt request can be processed with the assistance specialized hardware and software. For example the peripheral transaction server 232 and the interrupt service routine 234 can be responsible for prioritizing interrupts and responsible to ensure that interrupts with a higher priority are serviced before interrupts of a lower priority. Numerous interrupt requests could be placed in interrupt stack 204 where higher priority interrupts are placed at the top of the interrupt stack 204 and wherein the interrupts at the top of the interrupt stack 204 are processed first.

The peripheral transaction server 232 and the interrupt service routine 234 can also assist the CPU core 202 in storing its contents including the CPU core's current instructions and data, and help the CPU core 202 load instructions according to the interrupt request and help perform “housekeeping” process during the receipt processing and disposal of an interrupt request. Such procedures can make the CPU core 202 and the system generally more efficient by performing “housekeeping” functions every time an interrupted is detected by the snooper/decoder 208 on the bus. The snooper/decoder 208 can decode bus transactions occurring on a parallel bus to identify interrupts that are requested via a bus configuration.

Interrupt service routine 234 can represent a software service routine that facilitates specific processing during the handling of an interrupt. In addition, by setting and/or clearing individual bits in special function registers in the system 100, possibly in interrupt stack 204 specific entity based interrupts can be enabled and/or disabled. Thus, an interrupt request can be executed or ignored based on checking the interrupt sources enable/disable bit in the register. When the interrupt service routine 234 is interrupted by another interrupt source, the peripheral transaction server 232 can manage the interrupt requests and determine based on a set of predetermined criteria whether the current processing of an interrupt should or should not be preempted by the new interrupt request. In another embodiment the CPU core 202 may execute the interrupt by itself without specialized interrupt support.

In operation, the CPU core 202 can accept and store an interrupt request in the interrupt stack 204. The snooper/decoder 208 and the interrupt management module 214 can identify the device/peripheral entity sending the interrupt request based on bus traffic or based on other activities of the specific peripheral entity (i.e. 216 and 212). The snooper/decoder 208 and the interrupt management module 214 could be implemented as state machines.

The number of times that a particular entity 216 or 212 requests an interrupt during a particular time interval can be determined by the interrupt management module 214 with the assistance of timer 218 and counter 210. When an entity 216 and 212 has a high interrupt request rate or frequency, then the entity 216 and 212 can be identified in the malfunction candidate log 220 as a possible device for limiting CPU core disruption based on these interrupts. In one embodiment, the service processor can monitor the malfunction candidate log 202 and time permitting conduct a further investigation regarding why the entity is requesting the high number or a high frequency of interrupts. Interrogation of the entity and/or other system data could be utilized in such a failure analysis.

As stated above, interrupt counter 210 can count the number of interrupts for each device for the given time threshold. Timer 218 can be a programmable timer that can be set to predetermined time periods for each individual entity. Thus, some entities can be allowed a higher frequency of interrupts before they are recorded in the malfunction candidate log 220. When the interrupt per time period is reached the interrupt management module can administrate the appropriate procedure including logging abnormal interrupt activity and provide data regarding such activity to the service processor 232. The service processor 232 might interact with many systems including systems not shown herein, and could interact in a complex server maintenance environment to provide a user or a system administrator with various options for various control operations and notification methods.

Further, the information could be made available to network administrators as alarms or passive messages or merely in various formats when requested to assist users/administrators in locating and diagnosing system errors. In addition the interrupt management module 214 could access error logs in the service processor 232 to determine whether to add a peripheral entity into the malfunction candidate log 220 or to accept or ignore an interrupt request.

In one embodiment, the interrupt service routine 234 could check the interrupt stack 204 and the malfunction candidate log 220 periodically and determine valid interrupts. Such periodic review can be accomplished without significantly degrading system performance. More importantly when an entity is malfunctioning and sending superfluous interrupts, such a review and management of interrupt requests can prove very beneficial to the system 200. For example, when a processor is allowed to ignore superfluous interrupts system performance can be greatly enhanced. In addition such a detection system can provide input to failure detection and reporting system. The frequency of the interrupt requests from a particular entity can be analyzed during specific time intervals called interrupt counting sessions as determined by the timer 218. Thus, at the beginning of an interrupt counting session, the timer 218 and counter 210 can be reset and all entries in the malfunction candidate log 220 can be deleted. An interrupt counting session could also be defined as a time period starting when the CPU core 202 is powered up and lasting until a predetermined number of cock cycles occur, it could be real time or it could be a time period starting when a particular piece of software or subroutine is loaded and executed by an entity. A session could also be defined dynamically based on specific or general phenomena as detected by the interrupt manager module 214 or the CPU core 202. For example, the CPU core could send an instruction to a peripheral entity based on a received interrupt request to see if the entity can send an appropriate reply to the sent instruction.

The identifier can be an address that identifies the peripheral of the device and possibly what buss that the device resides on. Thus, the identifier can be the same address utilized by the system 200 for communicating between elements of the system 200. In another embodiment, the identifier can be a reduced, compressed or abbreviated version of the actual bus or device address or can be a specialize tag that is linked to peripheral entity.

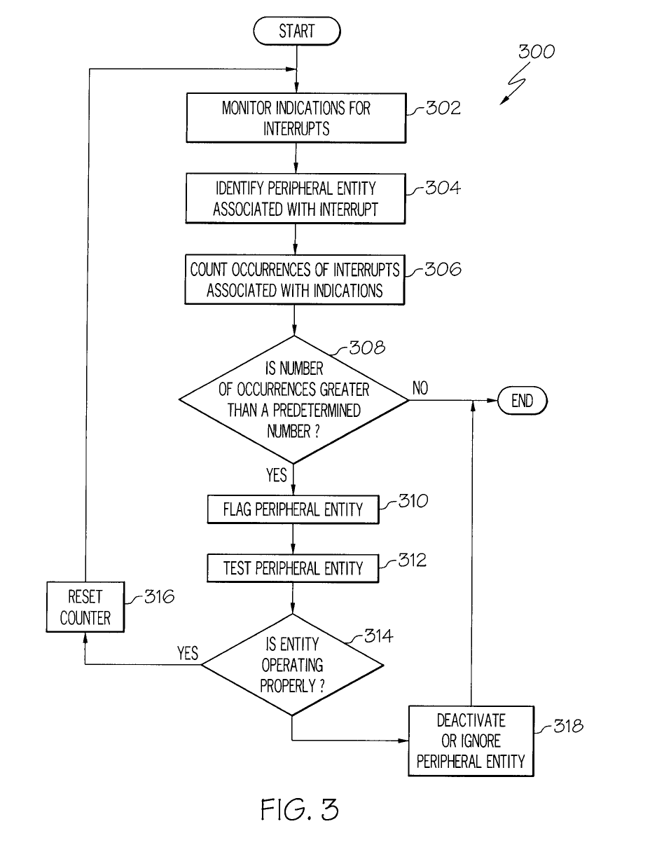

Referring to FIG. 3 a method for interrupt management is disclosed. As illustrated in block 302, an interrupt management module can monitor computer system activities for indications of interrupt requests. The interrupt requests that can be detected include a specific bit pattern being transmitted over a bus, a binary signal hard wired to the processor or other activity such activity within an interrupt register or activities of a component of an interrupt support system. The interrupt management module can monitor the system or interrupt requests and when an interrupt request is detected, the interrupt management module can determine the entity that generated the interrupt request or generated the indicator, as illustrated by block 304. As part of identifying the entity, the interrupt management module can acquire an existing identifier or it can be assigned an identifier.

As stated in the description of FIGS. 1 and 2 peripheral entities can be software entities or hardware entities. The entities can also have an identifier that may be pre-assigned and possibly utilized in specific processing tasks or the interrupt management module might assign the identifier to each entity as interrupt requests occur. As illustrated by block 306, the occurrences of interrupts can be counted. In one embodiment, the occurrences of activity associated with interrupts can be counted and not the actual interrupt signals. Counting interrupt occurrences may be done for predetermined time periods and such a counting procedure can be achieve utilizing a counter and a timer and in one embodiment combinational logic.

As illustrated by decision block 308, the interrupt management module can determine if the number of interrupt related occurrences is greater than a predetermined number. When the number of occurrences has not reached the predetermined number then the process can end or can revert back to block 302 where the system can continue to monitor for interrupts. When the number of counted interrupts or occurrences is greater than the predetermined number then the peripheral entity can be flagged as possibly having a problem as illustrated by block 310.

An identifier identifying the flagged peripheral entity and the number of interrupt requests in a given time interval or multiple time intervals can be stored in a malfunction candidate log. Thus, if a peripheral entity is malfunctioning and sending a large number of interrupts to the processor in a given period of time, the entity can be flagged for further testing or analysis. Such, activity commonly occurs when an entity (software and/or hardware) is stuck in a loop and will continually request an interrupt from the processor. In such a condition, the processor can complete a requested interrupt from the entity stuck in the loop and, the same entity will typically immediately requests another interrupt because it is stuck in an infinite processing loop.

As illustrated in block 312 the flagged peripheral entity can be checked, tested or interrogated to determine if it is operating properly. As illustrated in decision block 314 it can be determined if the entity is operating properly. When it is determined that the entity is operating properly the counter value for the entity can be reset. When it is determined that the entity is not operating properly then the entity can be deactivated or the interrupt requests can be ignored by the processor as illustrated by block 318. In alternate embodiments the entity can be reported to a service processor or some other reliability based system. The process can end thereafter.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present invention, represent embodiments of the present disclosure.

The disclosed embodiments can take the form of an entirely hardware embodiment, an entirely software embodiment or an embodiment containing both hardware and software elements. In one embodiment, the disclosed method is implemented utilizing software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and interrupt memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present invention contemplates methods, systems, and media that provide interrupt management. It is understood that the form of the invention shown and described in the detailed description and the drawings are to be taken merely as examples. It is intended that the following claims be interpreted broadly to embrace all the variations of the example embodiments disclosed.

What is claimed is:

1. A method for managing interrupts comprising:
monitoring a system for an indication of an interrupt request;
identifying a peripheral entity associated with the interrupt request;
determining an identifier of the peripheral entity;
incrementing an occurrence count associated with the identifier based on the monitoring of the indications; and
flagging the peripheral entity in response to a predetermined number of counted occurrences.

2. The method of claim 1, further comprising setting a predetermined time interval and setting a predetermined number of acceptable interrupt requests to occur in the predetermined time interval.

3. The method of claim 2, further comprising ignoring interrupt requests from the peripheral entity in response to the counted occurrences reaching the predetermined number of occurrences in the predetermined time interval.

4. The method of claim 2, further comprising deactivating the peripheral entity in response to the counted occurrences reaching the predetermined number of occurrences in the predetermined time interval.

5. The method of claim 1, further comprising assigning an identifier to the peripheral entity in response to an absence of an identifier of the peripheral entity,

6. The method of claim 5, further comprising storing the assigned identifier in a candidate register in response to occurrences of a flagged periphery entity.

7. The method of claim 1, further comprising incrementing a count associated with the identifier in response to detecting the indicator.

8. The method of claim 1, further comprising sending a notification to a performance monitoring system indicating that a peripheral entity has been flagged in response to the counted occurrences reaching the predetermined number of occurrences in the predetermined time interval.

9. A processing system comprising:
a processor;
interrupt management module coupled to the processor to determine indications of interrupt requests directed to the processor, the indications having an identifier relating the interrupt request to a peripheral entity;
a counter to count the occurrences of the interrupt requests during a predetermined time interval; and
a periphery entity malfunction log module to store the identifier responsive to the count of occurrences during the predetermined time interval.

10. The processing system of claim 9, further comprising a timer to determine the predetermined time interval.

11. The processing system of claim 9, further comprising a service processor to query the periphery entity associated with the periphery entity malfunction log and to determine if the interrupts from the periphery entity should be executed.

12. The processing system of claim 9, further comprising a peripheral transaction server to process the interrupts.

13. The processing system of claim 9, further comprising an interrupt service routine module to provide executable interrupt code to the processor wherein the processor executes the interrupt code.

14. A computer program product comprising a computer useable medium having a computer readable program, wherein the computer readable program when executed on a computer causes the computer to:
monitor a system for an indication of an interrupt request;
identify a peripheral entity associated with the interrupt request;
determine an identifier of the peripheral entity;
increment an occurrence count associated with the identifier based on the monitoring of the indications; and
flag the peripheral entity in response to a predetermined number of counted occurrences.

15. The computer program product of claim 14, further comprising a computer readable program when executed on a computer causes the computer to set a predetermined time interval and set a predetermined number of acceptable interrupt requests to occur in the predetermined time interval.

16. The computer program product of claim 14, further comprising a computer readable program when executed on a computer causes the computer to ignore the peripheral entity in response to the predetermined number of occurrences in the predetermined time interval.

17. The computer program product of claim 14, further comprising a computer readable program when executed on a computer causes the computer to deactivate the peripheral entity in response to the predetermined number of occurrences in the predetermined time interval.

18. The computer program product of claim 14, further comprising a computer readable program when executed on a computer causes the computer to assign an identifier to the peripheral entity.

19. The computer program product of claim 14, further comprising a computer readable program when executed on a computer causes the computer to store the assigned identifiers in a register of in response to flagged peripheral entity.

20. The computer program of claim 14, further comprising a computer readable program when executed on a computer causes the computer to increment a count for a peripheral entity indicator in response to detecting the indicator.
